(19) United States
(12) Patent Application Publication
(10) Pub. No.: US 2011/0286145 A1
(43) Pub. Date: Nov. 24, 2011

(54) ARRANGEMENT HAVING A DIELECTRIC BETWEEN AT LEAST TWO CONDUCTING SURFACES AND FEED-THROUGH FOR HIGH VOLTAGES

(75) Inventors: Achim Langens, Lohmar (DE); Christian Paul, Alfter (DE); Tim Schnitzler, Kreuzau (DE)

(73) Assignee: SIEMENS AKTIENGESELLSCHAFT, MUENCHEN (DE)

(21) Appl. No.: 13/146,695

(22) PCT Filed: Jan. 18, 2010
(86) PCT No.: PCT/EP2010/050530

§ 371 Date: Jul. 28, 2011

(30) Foreign Application Priority Data
Feb. 2, 2009 (DE) 10 2009 007 583.6

(51) Int. Cl. H01G 4/35; H01G 4/08

(52) U.S. Cl. 361/302; 361/323

(57) ABSTRACT

An assembly has at least two conducting surfaces and a dielectric therebetween formed of a plastic nonwoven fabric that is impregnated with cast resin. A corresponding feed-through for high voltages has a central conductor, around which conducting intermediate layers concentrically spaced from each other are arranged as conducting surfaces. A plastic nonwoven fabric impregnated with cast resin is located between the conducting intermediate layers as a dielectric.

Arrangement having a dielectric between at least two conducting surfaces and feed-through for high voltages

It has long been known to produce a feed-through for high voltages by using paper in the form of a strip to make a wound body in which conducting inserts have been introduced for voltage control. Water is subsequently extracted from the paper of the wound body in an energy-intensive and time-consuming process; this is followed by impregnating the wound body in an impregnating liquid. If a casting resin is used as the impregnating liquid, usually a creped paper is used, in order to ensure sufficient impregnation with the relatively viscous casting resin. However, this has the effect that the initially smooth conducting inserts adapt themselves to the creping, as a result of which the conducting inserts take on an irregular surface structure with peaks over their extent and at the periphery, causing local increases in the electric field; these in turn reduce the electrical load-bearing capacity of the dielectric between the conducting inserts.

European patent specification EP 1 060 480 B1 also discloses a feed-through for a high electrical voltage that dispenses with the use of paper to form the dielectric, in that a combination of at least one layer of a film and a layer of a nonwoven is used to create the dielectric. Both the film and the nonwoven are of synthetic material. A wound body, formed in this way, of the known feed-through is impregnated with gas or oil, for which reason the wound body must be surrounded by a sealed housing.

The invention is firstly based quite generally on the object of providing an arrangement having at least two conducting surfaces with a dielectric that is comparatively simple to produce and can be subjected to high electrical loading.

According to the invention, a solution achieving this object is an arrangement having at least two conducting surfaces, between which there is a synthetic nonwoven fabric that is impregnated with casting resin as a dielectric.

A major advantage of the arrangement according to the invention is that, because of the use of a synthetic nonwoven fabric, casting resin can be used as an impregnating agent because, in spite of its high viscosity, it can penetrate well into the synthetic nonwoven fabric. A further substantial advantage is seen in that the conducting surfaces retain their uniform surface, and consequently also a uniform spacing, so that the arrangement according to the invention can be subjected to comparatively great electrical loads. In addition, the arrangement according to the invention does not have to be enclosed in a housing because, after it has cured, the casting resin is confined in the arrangement and the overall arrangement forms a compact block. Mention should also be made of the advantage that, in comparison with the use of paper, water is mainly only superficially adsorbed on a synthetic nonwoven fabric, so that the water content is relatively low, which has favorable effects on the drying time and the energy requirement for drying. There is also the advantage that the moisture absorption of the impregnated wound body when stored in damp conditions is relatively low and takes place comparatively slowly. Moreover, absorbed moisture is given off quickly and virtually completely. The low moisture content also has a positive effect on the electrical and dielectric properties, such as for example conductivity and loss factor.

In the case of the arrangement according to the invention, differently produced synthetic nonwoven fabrics may be used; for example, synthetic nonwoven fabrics in which the filaments forming the nonwoven fabric are chemically bonded may be used. However, it has proven to be particularly advantageous if the synthetic nonwoven fabric is a thermally bonded synthetic nonwoven.

In principle, various materials come into consideration for the synthetic resin, for example polypropylene. However, it has been found that the synthetic nonwoven fabric advantageously consists of polyester.

Furthermore, it is regarded as advantageous if the polyester consists of continuous filaments.

The arrangement according to the invention may be structurally configured in very different ways. For example, it may form a plate capacitor or else be configured as a wound capacitor, in that the conducting surfaces then consist of metal foils or of conducting or semiconducting layers on a flexible carrier material.

In the case of a particularly preferred embodiment of the arrangement according to the invention, the synthetic nonwoven fabric is in the form of a strip and is wound up to form a wound body, conducting surfaces formed by film-like metal strips being wound in to form concentric conductive cylinders.

The invention is also based on the object of proposing a feed-through for high voltages that can be simply produced and can be subjected to high electrical loads.

According to the invention, serving as a solution to achieve this object is a feed-through for high voltages with a central conductor, arranged around which are conducting inserts spaced concentrically from one another, between which there is a synthetic nonwoven fabric that is impregnated with casting resin as a dielectric.

This feed-through according to the invention is distinguished by all the advantages that have already been presented above in connection with the arrangement according to the invention.

Further preferred refinements of the feed-through according to the invention are provided by claims 7 to 10 to achieve the corresponding advantages as specified above in relation to the corresponding forms of the arrangement according to the invention.

It should be emphasized that, in the case of the feed-through according to the invention, a fastening flange can be advantageously applied directly to the wound body, which is not possible in the case of the feed-through according to the patent discussed at the beginning.

For further explanation of the invention,

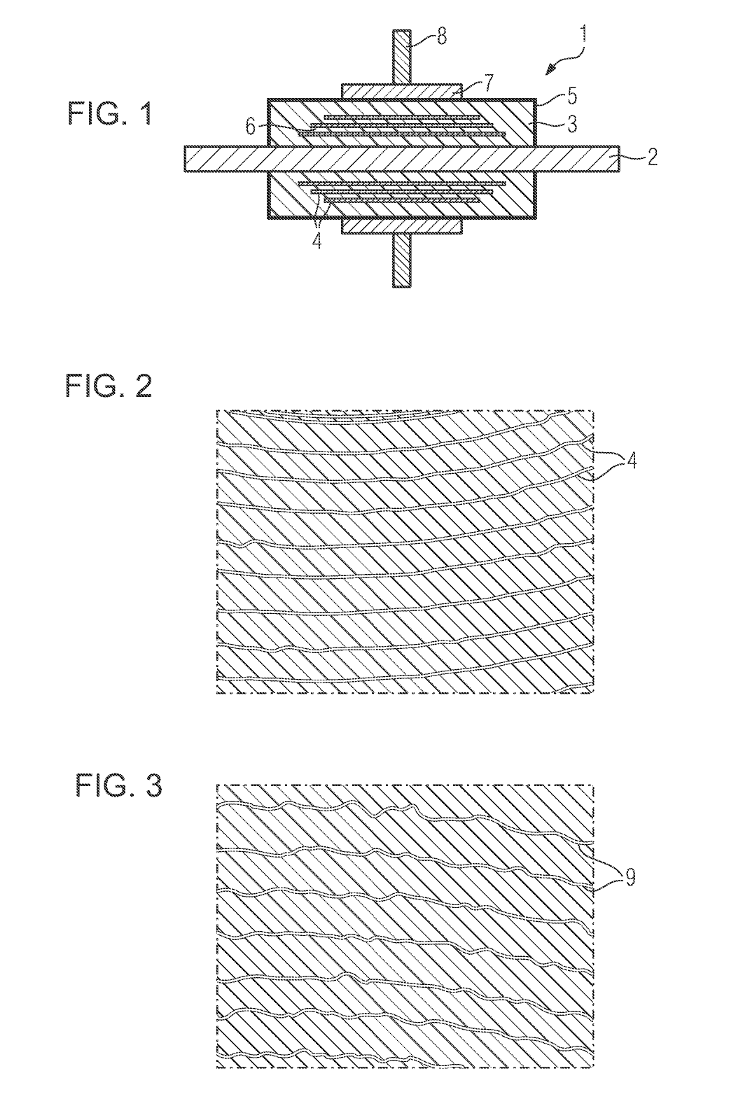

FIG. 1 shows an exemplary embodiment of a feed-through according to the invention for high voltages,

FIG. 2 shows a section through the exemplary embodiment that is shown in FIG. 1 and

FIG. 3 shows a section through a known feed-through with a dielectric of paper and casting resin.

The exemplary embodiment that is shown in FIG. 1 exhibits a feed-through 1, which has a central conductor 2 that is under high voltage. A thermally bonded synthetic nonwoven of continuous polyester filaments in the form of a strip has been applied to the central conductor 2 to form a wound body 3. When producing the wound body 3, conducting surfaces in the form of film-like metal strips are also wound in to form concentric conducting inserts 4. The wound body 3 formed in this way is impregnated with casting resin, so that, after the casting resin has cured, a compact, stable feed-through body 5 is obtained; therefore, between the conducting inserts 4 there is then a synthetic nonwoven fabric, filled with casting resin, as a dielectric 6. Fastened to the feed-through body 5 is a flange 7, with which the feed-through 1 is fastened in the region of a hole on a grounded wall 8 of a high-voltage installation (not shown).

FIG. 2 shows part of a cross section through the feed-through 1 according to FIG. 1 and reveals that the conducting inserts 4 that are spaced apart from one another have retained a uniform spacing from one another and have also virtually retained their uniform surface structure, while the corresponding representation according to FIG. 3 for a feed-through with paper and casting resin shows metal inserts 9 that have changed in their surface structure to form many pointed elevations in a disadvantageous way, because the electrical load-bearing capacity is reduced considerably by these peaks.

1-11. (canceled)

12. An assembly, comprising:
at least two electrically conducting surfaces; and
a dielectric disposed between said conducting surfaces, said dielectric being formed of a synthetic nonwoven fabric impregnated with a casting resin.

13. The assembly according to claim 12, wherein said synthetic nonwoven fabric is a thermally bonded synthetic nonwoven.

14. The assembly according to claim 12, wherein said synthetic nonwoven fabric consists of polyester.

15. The assembly according to claim 14, wherein said polyester is formed of continuous filaments.

16. The assembly according to claims 12, wherein said synthetic nonwoven fabric is a strip wound up to form a wound body, and wherein metallic foil strips forming conducting surfaces are wound in to form concentric conductive cylinders.

17. A feed-through assembly for a high voltage, comprising:
a central conductor;
conducting inserts forming conducting surfaces disposed around said central conductor and concentrically spaced from one another; and
a dielectric disposed between said conducting inserts, said dielectric being a synthetic nonwoven fabric impregnated with casting resin.

18. The feed-through according to claim 17, wherein said synthetic nonwoven fabric is a thermally bonded synthetic nonwoven.

19. The feed-through according to claim 17, wherein said synthetic nonwoven fabric consists of polyester.

20. The feed-through according to claim 19, wherein said polyester consists of continuous filaments.

21. The feed-through according to claims 17, wherein said synthetic nonwoven fabric is a strip wound up to form a wound body, and wherein metallic foil strips forming conducting surfaces are wound in to form concentric conductive cylinders.

22. The feed-through according to claim 12, wherein a fastening flange is applied directly to the wound body.
